(19) United States
(12) Patent Application Publication
(10) Pub. No.: US 2016/0216235 A1
(43) Pub. Date: Jul. 28, 2016

(54) Electrophoresis Medium Receptacle and Electrophoresis Apparatus

(71) Applicant: HITACHI HIGH-TECHNOLOGIES CORPORATION, Tokyo (JP)

(72) Inventors: Hitoshi MIYATA, Tokyo (JP); Tomoyuki KATO, Tokyo (JP); Toshiyuki SAKURAI, Tokyo (JP); Motohiro YAMAZAKI, Tokyo (JP)

(21) Appl. No.: 14/914,801

(22) PCT Filed: Jun. 30, 2014
(86) PCT No.: PCT/JP2014/067321

§ 371 Date: Feb. 26, 2016

(30) Foreign Application Priority Data
Sep. 12, 2013 (JP) 2013-189804

(51) Int. Cl. G01N 27/447

(52) U.S. Cl. CPC G01N 27/44791; G01N 27/44713; G01N 27/44721; G01N 27/44743

(57) ABSTRACT

During filling of a capillary with an electrophoresis medium, this electrophoresis medium receptacle maintains a resting state, and the capillary and the electrophoresis medium receptacle are readily sealed. The electrophoresis medium receptacle is simple in shape, the electrophoresis medium receptacle is readily manufactured, and the electrophoresis medium is readily sealed. The amount of the electrophoresis medium sealed in the electrophoresis medium receptacle is brought into approximation without limit to the amount of the electrophoresis medium filling the capillary, minimizing dead volume. In this electrophoresis medium receptacle, a receptacle filled with an electrophoresis medium is maintained in a sealed state, and a septum which can be pierced by a capillary cathode end is provided. The pressure produced when the capillary cathode end pierces the septum in which the receptacle filled with the electrophoresis medium is sealed transports the electrophoresis medium into the interior of a capillary.

### TECHNICAL FIELD

The present invention relates to an electrophoresis medium receptacle and an electrophoresis apparatus. For example, the present invention relates to an electrophoresis medium receptacle suitable for a capillary electrophoresis apparatus which separates and analyzes a sample such as DNA, or protein, through electrophoresis.

### BACKGROUND ART

In recent years, as an electrophoresis apparatus, a capillary electrophoresis apparatus, in which a capillary is filled with an electrophoresis medium such as a polymer gel or a polymer solution, has been widely used.

For example, a capillary electrophoresis apparatus disclosed in PTL 1 has been used conventionally. In the capillary electrophoresis apparatus, heat dissipation is high and it is possible to apply higher voltage to a sample, compared to a flat plate type electrophoresis apparatus, and thus, it is advantageous that it is possible to perform electrophoresis at a high speed. In addition, there are many advantages in that performing with a trace of sample, automatic filling of an electrophoresis medium, and automatic injection of a sample can be performed, and thus, the capillary electrophoresis apparatus is used for various types of separation and analysis measurements including analysis of nucleic acids or proteins.

FIG. 1 is a view illustrating an overview of a capillary electrophoresis apparatus according to the related art. The capillary electrophoresis apparatus is configured to include a capillary 101, a high voltage power source 102 which applies high voltage to both ends of the capillary 101, a constant-temperature oven 103 which controls the temperature of the capillary 101, an electrophoresis medium filling unit 104 which fills the capillary 101 with an electrophoresis medium, or the like. In addition to the configuration, although not illustrated, the capillary electrophoresis apparatus also includes an irradiation system having a laser beam source or the like, a receiving optical system which detects fluorescence, a transport machine which transports a receptacle in which a sample is contained, or the like.

An anode side of the capillary 101 is joined to a flow path of the electrophoresis medium filling unit 104. The flow path in the electrophoresis medium filling unit 104 is diverged into two flow paths. One flow path is joined to an electrophoresis medium receptacle 105 and the other flow path is joined to a buffer solution receptacle A 106.

In the capillary electrophoresis apparatus, an electrophoresis medium having viscosity higher than hundreds of times that of water needs to be injected into the capillary 101 having an inner diameter of only about 50 μm. Therefore, for the electrophoresis medium filling unit 104, a mechanism, which can apply pressure of several MPa to one end of the flow path for the electrophoresis medium, is employed. As the type of mechanism, for example, a plunger pump 107 is used. In the case in FIG. 1, the plunger pump 107 is driven in a direction perpendicular to the paper surface. In this manner, a volume inside the flow path is changed, and thus, pressure which is necessary to perform filling with the electrophoresis medium is generated.

During analysis of a sample, high voltage is applied to both ends (to the buffer solution receptacle A 106 and a buffer solution receptacle B 109) of the flow path connected to the capillary 101 and electrophoresis of a sample such as DNA having florescence marker is caused to be performed in the electrophoresis medium of the capillary 101. An electrophoresis rate is different depending on a molecule size, and thus, the sample is detected by the detector 108.

Incidentally, in the capillary electrophoresis apparatus, the electrophoresis medium receptacle 105 and the capillary 101 need to be replaced. However, at the time of the replacement, a part of the flow path is exposed to the air, thereby making it possible for the air to be mixed in the flow path.

During the electrophoresis, high voltage of several to tens of kV is applied to both ends of the flow path. Accordingly, in a case where bubbles exist in the flow path, there is a possibility that the flow path is electrically shut off due to the bubbles. In the case where the flow path is electrically shut off, a high voltage difference is generated at a shut-off position, which results in discharge. Depending on a magnitude of the discharge, there is a possibility that the capillary electrophoresis apparatus is damaged.

Therefore, there is a need to remove bubbles from the inside of the flow path before the electrophoresis starts.

For example, in a case where bubbles exist in the flow path of the electrophoresis medium filling unit 104, a connection flow path between the electrophoresis medium filling unit 104 and the capillary 101 is blocked and, in this state, the electrophoresis medium flows back to the buffer solution receptacle A 106 through a diverged path in the unit. In this manner, bubbles are removed from a flow path zone of the electrophoresis medium filling unit 104. Existence of bubbles in the flow path in the electrophoresis medium filling unit 104 is visually checked by a user.

In comparison, in a case where bubbles exist in the flow path of the capillary 101, the capillary 101 is filled with the electrophoresis medium by an amount of twice an interior volume of the capillary 101. At this time, the capillary 101 is thin with the inner diameter of about 50 μm. Accordingly, the bubbles flow in the capillary 101 along with the electrophoresis medium and are discharged from the other end side of the capillary 101. In other words, bubbles can be removed from the inside of the capillary 101.

For example, PTL 2 discloses a structure in which a need to visually check bubbles in the electrophoresis medium filling unit is eliminated such that the difficulty level of operation of an electrophoresis apparatus is lowered. Specifically, the electrophoresis medium filling unit is mounted in an attachable and detachable mode. Only in a case where filling with the electrophoresis medium is performed, the unit is connected to a capillary. During electrophoresis, both ends of the capillary are directly immersed in a buffer solution, thereby making it possible for the flow path of the electrophoresis medium filling unit to be removed from the flow path during the electrophoresis and making it possible not to check bubbles before the electrophoresis.

### CITATION LIST

### Patent Literature

PTL 1: Japanese Patent No. 2776208

PTL 2: JP-A-2012-2585

### SUMMARY OF INVENTION

### Technical Problem

As a result of an intensive study, the following problems have been found by the inventors of the present application. In the capillary electrophoresis apparatus disclosed in PTL 2 described above, since the electrophoresis medium receptacle moves during the filling of the capillary with the electrophoresis medium, it is difficult to maintain close contact (sealing) between the capillary and the electrophoresis medium receptacle, which is the first problem. In addition, since the electrophoresis medium receptacle has a complicated structure, it is difficult to manufacture the electrophoresis medium receptacle and there is difficulty in terms of the sealing of the electrophoresis medium, which is the second problem. Further, there is a significant amount of electrophoresis medium which is not used for filling the capillary (dead volume), which is the third problem.

Therefore, the present invention solves the first to third problems and aims to provide an electrophoresis medium receptacle and an electrophoresis apparatus which realize the following first to third objects.

The first object is to maintain a resting state of the electrophoresis medium receptacle during filling of a capillary with an electrophoresis medium such that it is easy to seal the capillary and the electrophoresis medium receptacle.

The second object is to simplify a shape of the electrophoresis medium receptacle such that it is easy to manufacture the electrophoresis medium receptacle and it is easy to inject the electrophoresis medium.

The third object is to enable an amount of the electrophoresis medium sealed in the electrophoresis medium receptacle to be brought into approximation to an amount of the electrophoresis medium, with which the capillary is filled, without limit, such that a dead volume is minimized.

The above and other objects and new features of the present invention will become clear in the description of the present specification and with reference to the accompanying drawings.

### Solution to Problem

Brief description of an overview of representative embodiments of the inventions disclosed in the present application is as follows.

In other words, the representative electrophoresis medium receptacle includes a sealing member which maintains a receptacle main body filled with an electrophoresis medium, in a sealing state, and which can be pierced by the capillary.

The electrophoresis medium is supplied to the inside of the capillary due to pressure produced when the capillary pierces the sealing member that seals the receptacle main body filled with the electrophoresis medium.

In the electrophoresis medium receptacle, it is more preferable that the pressure produced, when the capillary pierces the sealing member, is pressure produced due to an increase in pressure in the receptacle main body, with compression of the electrophoresis medium, by an amount of a volume of the capillary inserted into the receptacle main body.

It is still more preferable that the volume of the capillary inserted into the receptacle main body is greater than the interior volume of the capillary.

In the electrophoresis medium receptacle, it is still more preferable that the sealing member is formed of a material which is likely to be elastically deformed and maintains the sealing state of the receptacle main body through elastic deformation, even when the capillary penetrates through the member. It is still more preferable that the sealing member is formed of rubber or a resin which is likely to be elastically deformed.

Further, the invention may be applied to an electrophoresis apparatus using the electrophoresis medium receptacle described above.

### Advantageous Effects of Invention

Brief description of effects obtained by representative embodiments of the inventions disclosed in the present application is as follows.

The first effect is that, when the capillary is filled with the electrophoresis medium, it is possible to maintain a resting state of the electrophoresis medium receptacle, and it is possible to easily seal the capillary and the electrophoresis medium receptacle.

The second effect is that a shape of the eiectrophoresis medium receptacle is simplified such that it is possible to easily manufacture the electrophoresis medium receptacle and it is possible to easily seal the electrophoresis medium.

The third effect is that it is possible to cause an amount of the electrophoresis medium sealed in the electrophoresis medium receptacle to be brought into approximation to an amount of the electrophoresis medium, with which the capillary is filled, without limit, such that a dead volume is minimized.

### BRIEF DESCRIPTION OF DRAWINGS

FIG. 1 is a view illustrating an overview of a capillary electrophoresis apparatus according to the related art.

FIG. 2 is a view illustrating an overview of an electrophoresis apparatus according to Embodiment 1 of the present invention.

FIG. 3 is a view illustrating a disassembled configuration of an electrophoresis medium receptacle according to Embodiment 1 of the present invention.

FIG. 4 illustrates views of an assembled state of the electrophoresis medium receptacle according to Embodiment 1 of the present invention.

FIG. 5 illustrates views of a state of using the electrophoresis medium receptacle according to Embodiment 1 of the present invention.

FIG. 6 illustrates views of a structure of a septum according to Embodiment 1 of the present invention.

FIG. 7 illustrates views of a structure of the electrophoresis medium receptacle according to Embodiment 1 of the present invention.

FIG. 8 illustrates views of an accommodation section of the electrophoresis medium receptacle according to Embodiment 1 of the present invention.

FIG. 9 is a view illustrating installation of the electrophoresis medium receptacle according to Embodiment 1 of the present invention.

FIG. 10 illustrates views of an installation state of the electrophoresis medium receptacle according to Embodiment 1 of the present invention.

FIG. 11 illustrates views of a filling state with an electrophoresis medium according to Embodiment 1 of the present invention.

FIG. 12 illustrates views of an electrophoresis medium receptacle according to Embodiment 2 of the present invention.

FIG. 13 illustrates views of a configuration of an electrophoresis medium receptacle according to Embodiment 3 of the present invention.

FIG. 14 illustrates views of a configuration of an electrophoresis medium receptacle according to Embodiment 4 of the present invention.

FIG. 15 illustrates views of a configuration of an electrophoresis medium receptacle according to Embodiment 5 of the present invention.

FIG. 16 is a view illustrating an overview of an electrophoresis apparatus according to Embodiment 5 of the present invention.

FIG. 17 is a view illustrating installation flow of the electrophoresis medium receptacle according to Embodiment 5 of the present invention.

FIG. 18 is a view illustrating a filling state with an electrophoresis medium according to Embodiment 5 of the present invention.

FIG. 19 is a view illustrating installation flow of an electrophoresis medium receptacle according to Embodiment 7 of the present invention.

FIG. 20 is a view illustrating a disassembled configuration of an electrophoresis medium receptacle according to Embodiment 8 of the present invention.

FIG. 21 illustrates views of the configuration of the electrophoresis medium receptacle according to Embodiment 8 of the present invention.

FIG. 22 illustrates views of a state of immediately after insertion of a capillary cathode end according to Embodiment 8 of the present invention.

FIG. 23 illustrates views of the insertion state of the capillary cathode end according to Embodiment 8 of the present invention.

FIG. 24 illustrates views of a capillary array according to Embodiment 9 of the present invention.

FIG. 25 is a view illustrating a capillary array according to Embodiment 10 of the present invention.

FIG. 26 is a view illustrating an overview of an electrophoresis apparatus according to Embodiment 10 of the present invention.

FIG. 27 illustrates views of a filling state with an electrophoresis medium according to Embodiment 11 of the present invention.

FIG. 28 is a view illustrating an overview of an electrophoresis apparatus according to Embodiment 12 of the present invention.

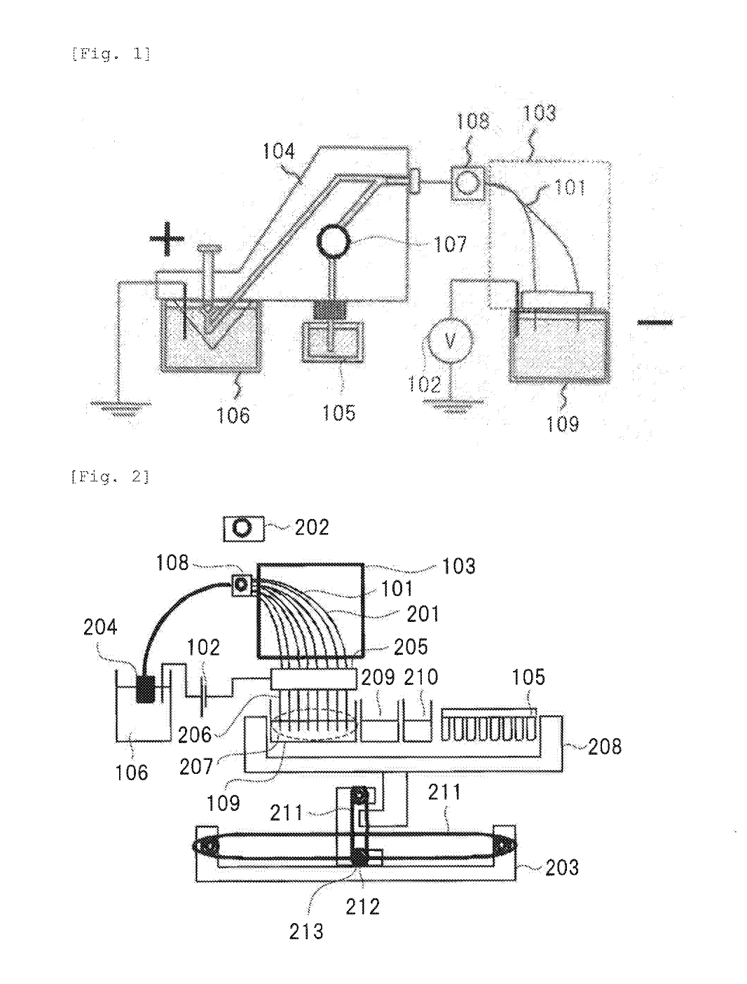

### DESCRIPTION OF EMBODIMENTS

The following embodiments are described by being divided into a plurality of sections or a plurality of embodiments, as necessary, for convenience; however, except for a case where particular description is provided, the embodiments are related to each other and, in the relationship, one embodiment is a part of or an entire modification example, detailed description, or supplementary description of the other embodiment. In addition, in the following embodiments, in a case where a number (including the number of, a value, an amount, a range, or the like) of components is described, there is no limitation to a particular number and a number may be equal to or greater than or equal to or less than the particular number, except for a case where particular description is provided and a case where there is a limitation to the particular number which is made clear by principle.

Further, in the following embodiment, it is needless to say that components (including a component step or the like) are not necessary, except for a case where particular description is provided or a case where the components are considered as necessary, which is made clear by principle. Similarly, in the following embodiment, when a shape, a positional relationship, or the like of components or the like, is described, the shape or the like includes substantially approximate or similar ones, except for a case where particular description thereof is provided or a case where the shape or the like is considered being wrong, which is made clear by principle. The same is true of values and ranges described above.

### Overview of Embodiment

First, an overview of an embodiment is described. In the overview of the present embodiment, as an example, reference signs are attached, in parentheses, to components corresponding to the embodiment.

In other words, the representative electrophoresis medium receptacle (electrophoresis medium receptacle 105) of the present embodiment includes a sealing member (septum 215) which maintains a receptacle main body (receptacle 214) filled with an electrophoresis medium, in a sealing state, and which can be pierced by the capillary. The electrophoresis medium is supplied to the inside of the capillary due to pressure produced when the capillary pierces the sealing member that seals the receptacle main body filled with the electrophoresis medium.

In the electrophoresis medium receptacle, it is more preferable that the pressure produced, when the capillary pierces the sealing member, is pressure produced due to an increase in pressure in the receptacle main body, with compression of the electrophoresis medium, by an amount of a volume of the capillary inserted into the receptacle main body. It is still more preferable that the volume of the capillary inserted into the receptacle main body is greater than the interior volume of the capillary.

In the electrophoresis medium receptacle, it is still more preferable that the sealing member is formed of a material which is likely to be elastically deformed and maintains the sealing state of the receptacle main body through elastic deformation, even when the capillary penetrates through the member. It is still more preferable that the sealing member is formed of rubber or a resin which is likely to be elastically deformed.

Further, the present invention is also applied to the electrophoresis apparatus which uses the electrophoresis medium receptacle.

Hereinafter, the respective embodiments will be described in detail based on the drawings and the overview of the embodiment described above. Further, in all the drawings for describing the respective embodiments, the same reference sign is assigned to a member having the same function by principle, and repetitive description thereof is omitted. In addition, in the respective embodiments, description of the same or similar portions is not repeated by principle.

In addition, in the drawings used in the respective embodiments, hatching in a sectional plane is omitted even in section views in some cases, such that the drawing is easily seen. Hatching is applied even in the plan view such that the drawing is easily understood.

### Embodiment 1

The electrophoresis apparatus according to the present embodiment is described with reference to FIGS. 2 to 11. Further, details of a configuration of the apparatus or an operation process in the following description are an example provided only to describe the invention, and do not limit a range of the invention. In addition, it is possible to realize other embodiments by combining or replacement between not only the respective embodiments but also between the respective embodiments and known technologies.

<Overview of Electrophoresis Apparatus>

FIG. 2 is a view illustrating an overview of the electrophoresis apparatus according to the present embodiment. Hereinafter, a configuration of the electrophoresis apparatus will be described with reference to FIG. 2.

A capillary electrophoresis apparatus according to the present embodiment includes one capillary 101 or a capillary array 201 as an aggregated set of a plurality of capillaries 101, a receiving optical system 202 which irradiates a sample in the capillary 101 with light and detects fluorescence from the sample, a high voltage power source 102 for applying high voltage to the capillary 101, a constant-temperature oven 103 for maintaining the capillary 101 at a constant temperature, and an auto-sampler 203 as a transport machine for transporting a tray 208 on which a plurality of receptacles, in which a sample, an electrophoresis medium, or the like is contained, are mounted.

One end of the capillary array 201 is a capillary head 204 formed of the capillaries 101 which are bundled and bonded. A detector 108 is provided at a portion at which the capillaries 101 are bundled. The other end of the capillary array 201 is held in a load header 205. The load header 205 is fixed to the constant-temperature oven 103.

A tube-shaped cathode electrode 206 is provided in the load header 205. The capillary 101 protrudes from a lower end (hereinafter, referred to as a capillary cathode end 207) of the cathode electrode 206 through the cathode electrode 206.

The capillary array 201 is filled with the electrophoresis medium by performing insertion of the capillary cathode end 207 into the electrophoresis medium receptacle. As will be described below, a position, at which insertion of the capillary cathode end 207 is performed, is maintained in a sealing state by using a septum which does not allow leakage even when penetration through the septum is performed.

On the tray 208, the buffer solution receptacle B 109 in which the capillary cathode end 207 is immersed, a pure water receptacle 209 in which pure water for cleaning the capillary is contained, an electrophoresis medium receptacle 105 in which the electrophoresis medium is contained, and a sample receptacle 210 in which the sample is contained, are mounted. Further, the capillary head 204 on the capillary anode end is immersed in the buffer solution receptacle A 106.

The auto-sampler 203 is configured to include two timing belts 211 corresponding to a rightward-leftward direction (horizontal direction: X) and an upward-downward direction (vertical direction: Y), respectively, in FIG. 2. Rotation of the two timing belts 211 enables the tray 208 to be transported in the rightward-leftward and upward-downward directions. The transport in two axial directions enables the respective receptacles mounted on the tray 208 to be positioned at a position facing the capillary cathode end 207. Further, the timing belts 211 are driven by the rotation of a motor 213 connected through a pulley 212.

<Structure of Electrophoresis Medium Receptacle>

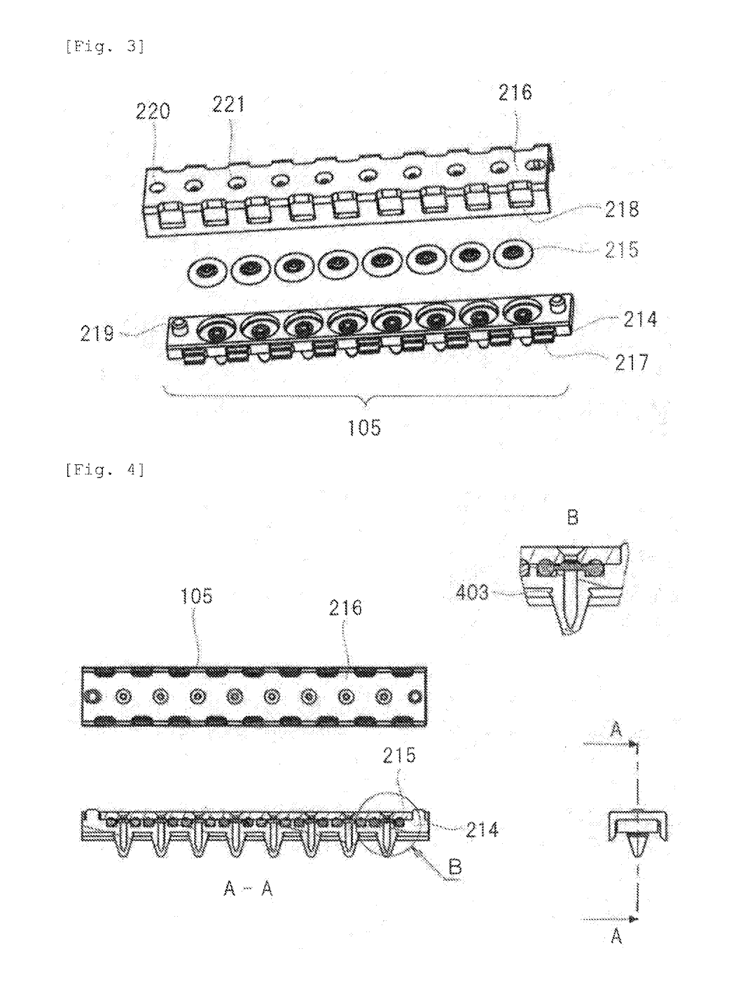

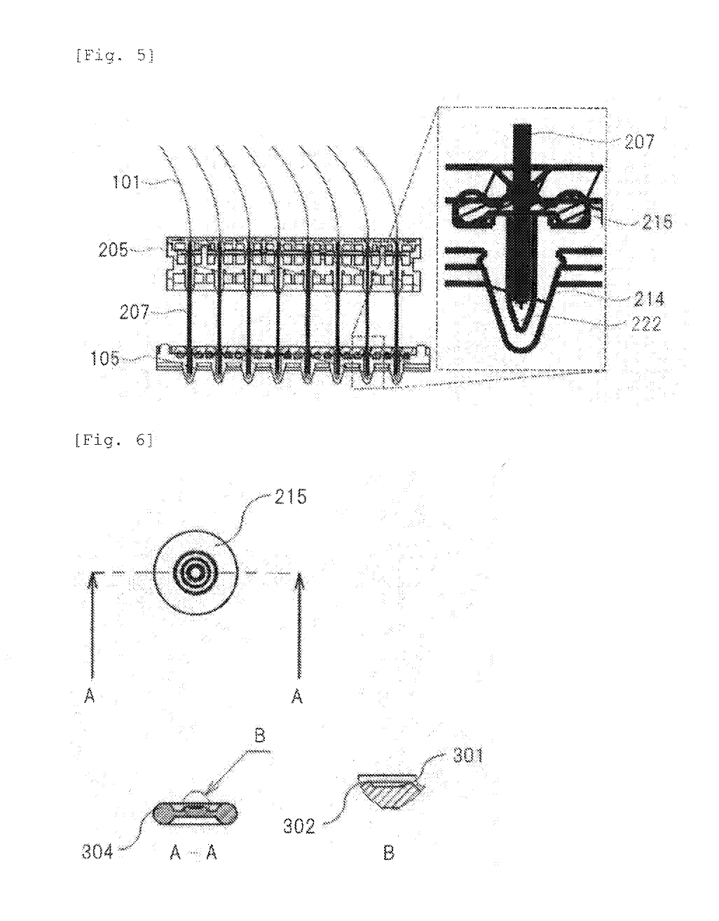

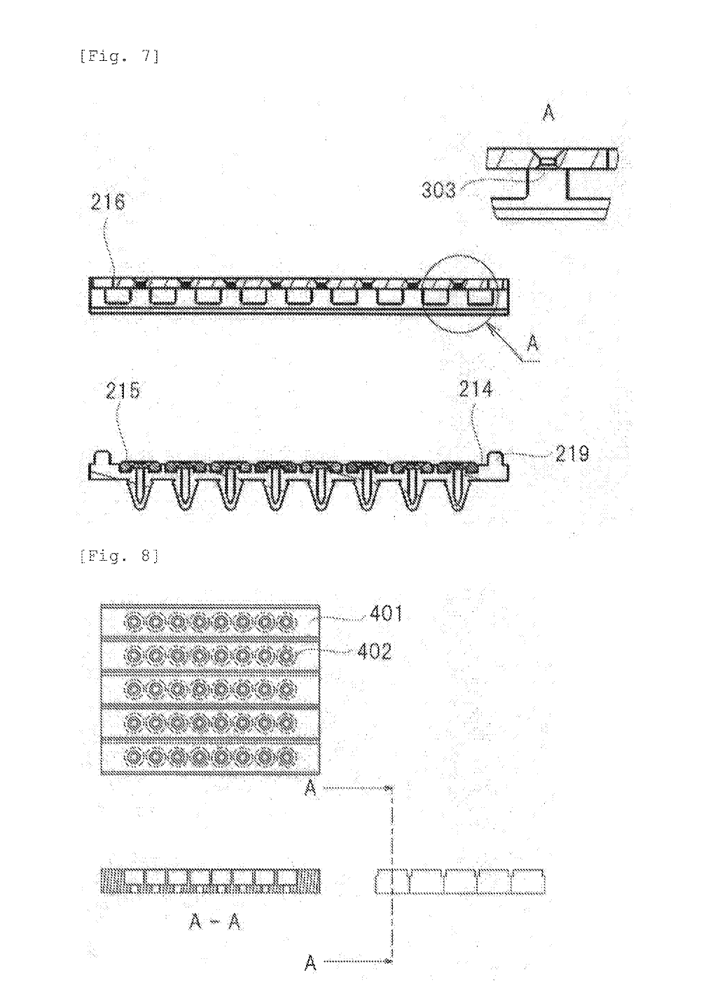

A configuration of the electrophoresis medium receptacle 105 employed in the capillary electrophoresis apparatus is described with reference to FIG. 3, FIG. 4, and FIG. 5. FIG. 3 is a view (exploded perspective view) illustrating a disassembled configuration of the electrophoresis medium receptacle 105. FIG. 4 illustrates views (a plan view, a side view, an A-A sectional view, and an enlarged sectional view of a B portion) of an assembled state of the electrophoresis medium receptacle 105. FIG. 5 illustrates views (a sectional view, a partial enlarged sectional view) of a state of using the electrophoresis medium receptacle 105.

As illustrated in FIG. 3, the electrophoresis medium receptacle 105 according to the present embodiment includes, for example, a polycarbonate receptacle 214, a silicon rubber septum 215, and a polycarbonate cover 216. The receptacle 214 and the cover 216 are not limited to the polycarbonate, but can be made of polypropylene, a COP resin, PMMA, or the like. In addition, the septum 215 is not limited to silicon rubber, but can be made of fluorine rubber, EPDM rubber, or the like.

The receptacle 214 has eight holes at a pitch of 9 mm in the horizontal direction. The holes have the diameter of φ 1.5 mm and a depth of 5.1 mm, and each of the holes has an inner volume in which the electrophoresis medium of about 9 μl is sealed.

The septum 215 is fixed by being interposed between the receptacle 214 and the cover 216. In addition to individual molding, the septum 215 may be integrally molded with the cover 216 through two-color molding or the like.

FIG. 4 illustrates a state in which the electrophoresis medium receptacle 105 is assembled from the disassembled state in FIG. 3. In the present embodiment, the receptacle 214 and the cover 216 are fitted to each other by fitting a snap fitting claw 217 provided in the receptacle 214 in a snap fitting hole 218 provided in the cover 216. In addition to the snap fitting, the receptacle 214 and the cover 216 may use fixing means such as an adhesive or ultrasonic bonding. At this time, a pin portion 219 provided in the receptacle 214 is inserted into a positioning hole 220 provided in the cover 216, and then a capillary cathode end inserting hole 221 is positioned. A round protrusion 403 is formed in the receptacle 214 and is used to play a role of fixing the electrophoresis medium receptacle 105, as will be described below.

FIG. 5 illustrates a state of using the electrophoresis medium receptacle 105 which is assembled as illustrated in FIG. 4. As illustrated in FIG. 5, an electrophoresis medium 222 is accommodated in the receptacle 214 of the electrophoresis medium receptacle 105. The capillary cathode end 207 of the capillary 101 penetrates through the septum 215. The capillary 101 and the septum 215 are arranged in the same way.

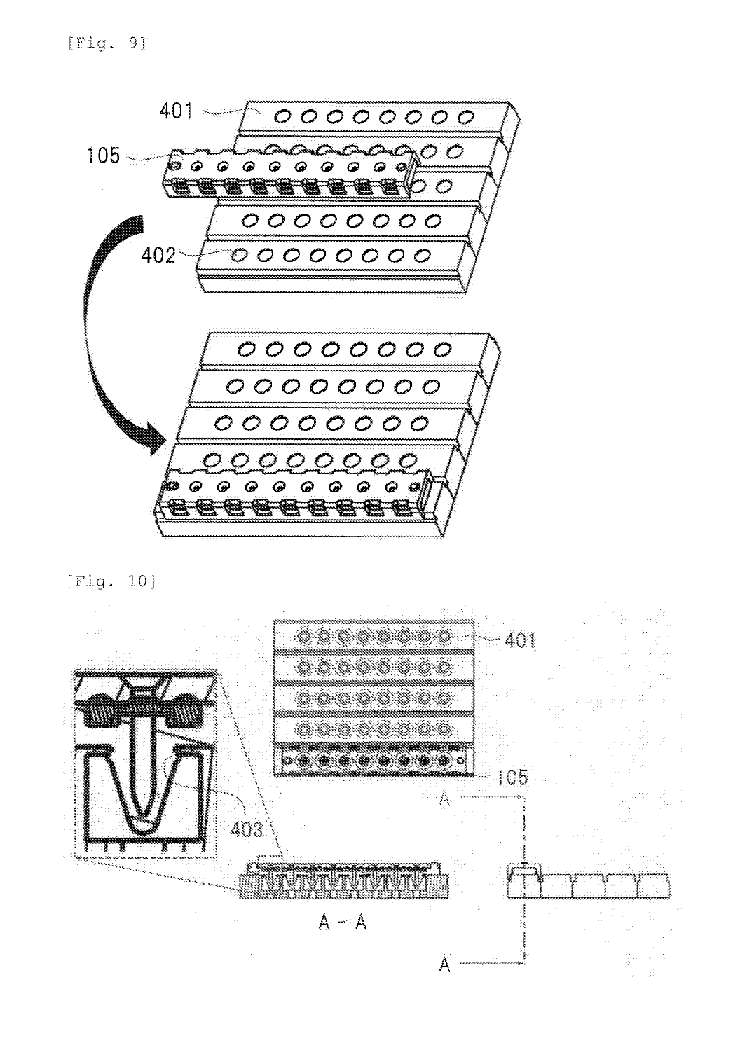

A structure of the septum 215 is described with reference to FIG. 6 and FIG. 7. FIG. 6 illustrates views (a plan view, an A-A sectional view, and an enlarged sectional view of a B portion) of a structure of the septum 215. FIG. 7 illustrates views (a sectional view of the cover, an enlarged sectional view of an A portion of the cover, and a sectional view of the septum and the receptacle) of a structure of the electrophoresis medium receptacle 105.

As illustrated in FIG. 6, the septum 215 has a recessed portion 301 at the center portion such that the capillary cathode end 207 easily penetrates therethrough. In addition, the septum 215 has a taper 302 around the recessed portion 301 such that an external force is normally applied to a penetration portion of the capillary cathode end 207. Meanwhile, as illustrated in FIG. 7, the cover 216 has a taper 303. The taper 303 of the cover 216 and the taper 302 of the septum 215 are provided at corresponding positions so as to come into contact with each other with predetermined pressure in a using state. Accordingly, as illustrated in FIG. 7, the taper 303 provided in the cover 216 comes into contact with the taper 302 provided in the septum 215, and thereby an external force is normally applied to the penetration portion of the capillary cathode end 207.

The external force acts in an orientation in which the opened hole is closed during the penetration of the capillary cathode end 207, and thus, the opened hole comes into close contact with the capillary cathode end 207. The more the interior pressure of the electrophoresis medium receptacle 105 is increased, the more the external force is increased. This is also effective in a case where the capillary cathode end 207 is pulled out from the septum 215, and thus, a liquid leakage does not occur because the hole is closed due to the external force. Further, an outer circumference 304 of the septum 215 has a structure of an O-ring. When the cover 216 is attached, in the structure, a gap between the septum 215 and the receptacle 214 is filled due to a crush margin of the outer circumference 304 and the electrophoresis medium 222 is prevented from evaporation and leakage.

<Operation of Overall Electrophoresis Apparatus>

Next, a series of processing operations by the electrophoresis apparatus according to the present embodiment will be described. Further, a drive operation of the auto-sampler 203 or an applying operation of voltage for performing electrophoresis in the electrophoresis apparatus to be described below is realized by a control unit (for example, a computer) (not illustrated).

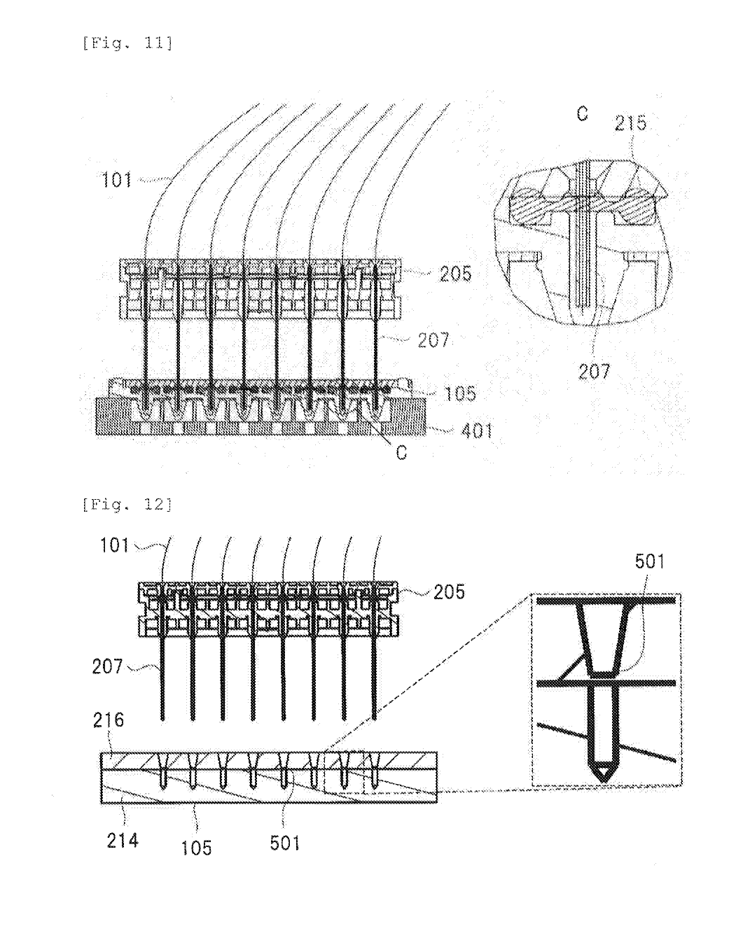

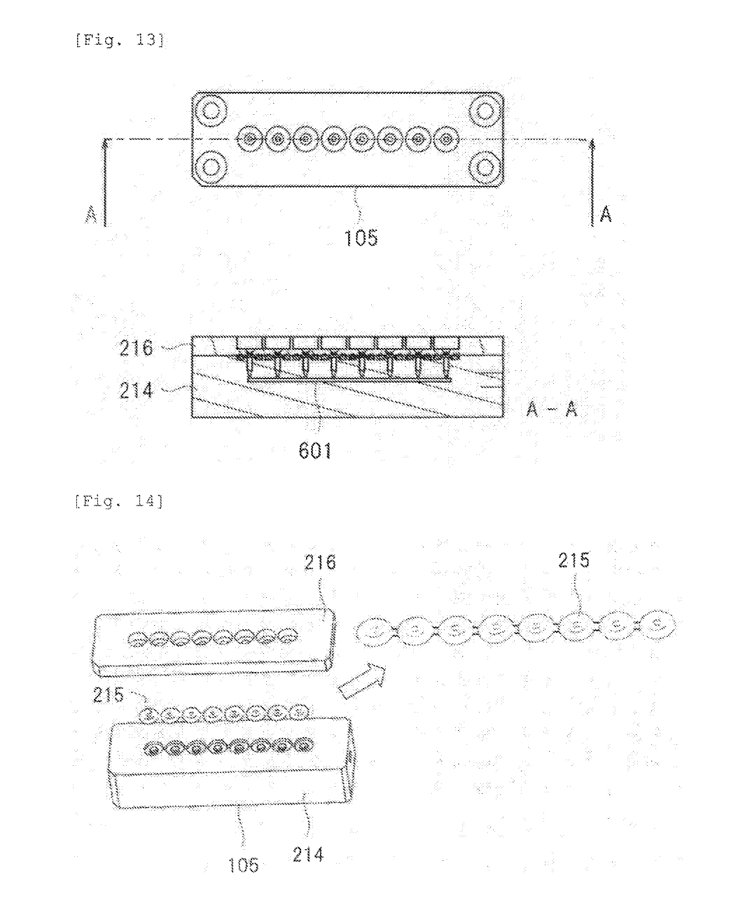

FIG. 8, FIG. 9, FIG. 10, and FIG. 11 illustrate processing steps performed when the capillary array 201 is filled with the electrophoresis medium 222. FIG. 8 illustrates views (a plan view, a side view, and an A-A sectional view) of an accommodation section of the electrophoresis medium receptacle 105. FIG. 9 is a view (perspective view) illustrating installation of the electrophoresis medium receptacle 105. FIG. 10 illustrates views (a plan view, a side view, an A-A sectional view, and an enlarged sectional view of a portion) of an installation state of the electrophoresis medium receptacle 105. FIG. 11 illustrates views (a sectional view and an enlarged sectional view of a C portion) of a filling state with an electrophoresis medium.

First, the electrophoresis medium receptacle 105 is installed in the accommodation section 401 of the tray 208. FIG. 8 illustrates the accommodation section 401 of the tray 208 and FIG. 9 illustrates a state in which the electrophoresis medium receptacle 105 is installed in the accommodation section 401. An electrophoresis medium receptacle positioning hole 402 is opened in the accommodation section 401 of the tray 208, the insertion of the electrophoresis medium receptacle 105 into the hole 402 allows the electrophoresis medium receptacle 105 to be positioned with respect to the capillary 101 with accuracy and correct repeatability.

In addition, a round protrusion 403 positioned on an outer circumference of a cylindrical section of the electrophoresis medium receptacle 105 plays a role of snap fitting, as illustrated in FIG. 10. A holding force is applied against an upward frictional force produced when the capillary cathode end 207 is pulled out such that the electrophoresis medium receptacle 105 is fixed.

Next, the tray 208 is driven in a horizontal direction by the auto-sampler 203 and the recessed portion 301 of the electrophoresis medium receptacle 105 is positioned at a position below the capillary cathode end 207.

Then, the tray 208 is lifted upward by the auto-sampler 203, the septum 215 of the electrophoresis medium receptacle 105 is penetrated, and the capillary cathode end 207 is inserted into the electrophoresis medium receptacle 105. FIG. 11 illustrates a state after the insertion of the capillary cathode end 207. Since a hole in the septum 215 is opened so as to match the shape of the capillary cathode end 207, the capillary cathode end 207 and the septum 215 are easily sealed.

In addition, an external force is normally applied toward a position of the septum 215, at which the capillary cathode end 207 penetrates. The external force acts in an orientation in which the opened hole is closed during the penetration of the capillary cathode end 207. Accordingly, during the penetration of the capillary cathode end 207, the opened hole and the capillary cathode end 207 are brought into close contact with each other. In this manner, leakage from the penetration portion by the capillary cathode end 207 is prevented. When the capillary cathode end 207 has an outer diameter of φ 0.71 mm, pressure resistance thereof can be about 8 MPa.

Due to the sealing of the septum 215, the electrophoresis medium 222 in the electrophoresis medium receptacle 105 is compressed by an amount of a volume of the insertion of the capillary cathode end 207, and thus, pressure is generated to cause the inside of the capillary 101 to be filled with the electrophoresis medium 222. Liquid supply pressure is equal to or higher than about 3 MPa with which the electrophoresis medium 222 is sufficiently injected. The volume of the insertion of the capillary cathode end 207 is greater than the interior volume of the capillary 101. In this manner, the electrophoresis medium 222 is supplied to the inside of the capillary 101 from the electrophoresis medium receptacle 105.

For example, in a case where an inner diameter of the capillary 101 is φ50 μm, a length of the capillary 101 is 360 mm, and an outer diameter of the capillary cathode end 207 of the capillary 101 is φ0.71 mm, the capillary cathode end 207 penetrates through the septum 215, and then is inserted by 3.67 mm, and an amount twice the interior volume of the capillary 101 can be supplied. The liquid supply pressure is lowered as the capillary 101 is filled with the electrophoresis medium 222. In response to the lowering of the liquid supply pressure, a filling rate of the capillary 101 with the electrophoresis medium 222 is lowered. Accordingly, the insertion state is maintained for about one to two minutes after the insertion of the capillary cathode end 207, and thereby the inside of the capillary 101 is filled with an amount of the electrophoresis medium 222, which is more equal to the volume of the insertion of the capillary cathode end 207.

When the filling of the capillary 101 with the electrophoresis medium 222 is completed, the tray 208 is transported downward by the auto-sampler 203 and the capillary cathode end 207 is pulled out from the electrophoresis medium receptacle 105.

Then, the auto-sampler 203 transports the tray 208 and the capillary cathode end 207 is immersed in the sample which is contained in the sample receptacle 210, in pure water (for cleaning) which is contained in a pure water receptacle 209, and in a buffer solution which is contained in the buffer solution receptacle B 109, in this order.

The electrophoresis is started in a state in which the capillary cathode end 207 is immersed in the buffer solution. Further, the capillary anode end (capillary head 204) is immersed in the buffer solution which is contained in the buffer solution receptacle A 106 until a series of processing operations are started. In this manner, the electrophoresis is performed in a state in which both end portions of the capillary are directly immersed in the buffer solution. In addition, during analysis of the sample, the sample is subjected to electrophoresis in the electrophoresis medium and a difference in the electrophoresis rates is detected by the detector 108.

After the completion of the electrophoresis, the user removes the electrophoresis medium receptacle 105 from the electrophoresis apparatus and throws away the electrophoresis medium receptacle as is. Accordingly, the user does not directly touch the electrophoresis medium 222 and the electrophoresis medium 222 is not attached to the electrophoresis apparatus.

### Effects of Embodiment 1

As above, in the electrophoresis apparatus according to the present embodiment, the electrophoresis medium receptacle 105 includes the septum 215, as the sealing member, which maintains the receptacle 214 filled with an electrophoresis medium 222, in a sealing state, and which can be pierced by the capillary cathode end 207. The electrophoresis medium 222 can be supplied to the inside of the capillary 101 due to the pressure produced when the capillary cathode end 207 pierces the septum 215 that seals the receptacle 214 filled with the electrophoresis medium 222.

In this case, the electrophoresis medium 222 can be supplied to the inside of the capillary 101 due to the pressure produced when the electrophoresis medium 222 is compressed by the amount of the volume of the insertion of the capillary cathode end 207 into the receptacle 214, and thus, the pressure in the receptacle 214 is increased. Since the septum 215 is molded of a rubber material which is likely to be elastically deformed, it is possible to maintain the sealing state in the receptacle 214 by the elastic deformation, even when the capillary cathode end 207 penetrates therethrough. In addition, even in a case where the capillary cathode end 207 is pulled out from the receptacle 214, it is possible to maintain the sealing state in the receptacle 214.

As a result, when the capillary 101 is filled with the electrophoresis medium 222, the electrophoresis medium receptacle 105 can maintain the resting state and it is possible to easily seal the capillary 101 and the electrophoresis medium receptacle 105. In addition, the shape of the electrophoresis medium receptacle 105 is simplified such that it is possible to easily manufacture the electrophoresis medium receptacle 105 and it is possible to easily perform the sealing of the electrophoresis medium 222. Further, the amount of the electrophoresis medium 222 which is sealed in the electrophoresis medium receptacle 105 can be brought into approximation to the amount of the electrophoresis medium, with which the capillary 101 is filled, without limit, and, as a result, it is possible to reduce the dead volume.

### Embodiment 2

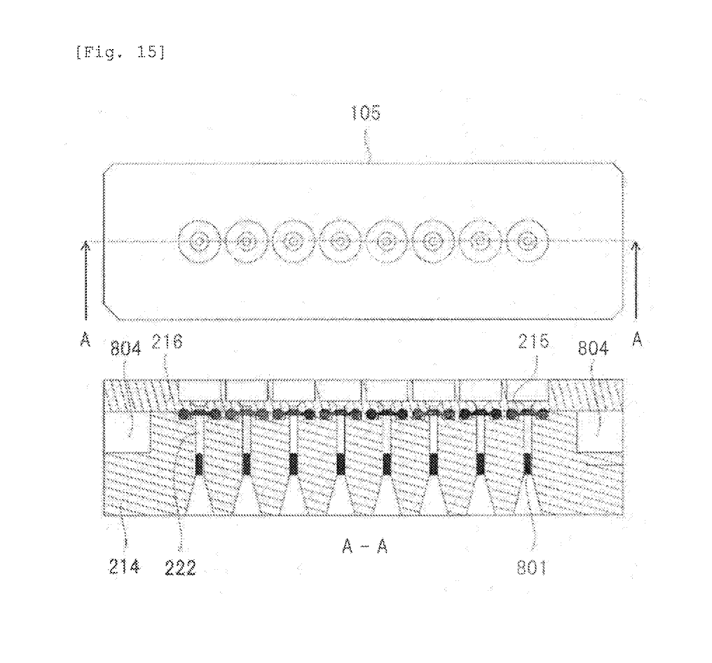

An electrophoresis apparatus according to the present embodiment is described with reference to FIG. 12. The present embodiment is described focusing on differences from Embodiment 1 described above.

In the capillary electrophoresis apparatus in the embodiment described above, the septum 215 of the electrophoresis medium receptacle 105 is manufactured of a rubber material. However, as long as the penetration position of the capillary cathode end 207 is sealed, rubber is not necessarily used. The capillary electrophoresis apparatus according to the present embodiment employs an example in which the septum 215 of the electrophoresis medium receptacle 105 is manufactured of a resin material and is described with reference to FIG. 12.

FIG. 12 illustrates views (a sectional view and an enlarged sectional view of a portion) of the electrophoresis medium receptacle 105 according to the present embodiment. As illustrated in FIG. 12, as components of the electrophoresis medium receptacle 105, the entire receptacle 214 and the entire cover 216 are manufactured of a resin and a capillary cathode end inserting portion 501 is thin in thickness of the resin. In addition, the capillary cathode end 207 has a sharp shape. The capillary cathode end 207 penetrates through and is inserted through the resin of the capillary cathode end inserting portion 501. After the insertion, since a hole matching the shape of the capillary cathode end 207 is opened in the resin, the electrophoresis medium receptacle 105 and the capillary cathode end 207 are sealed. In this manner, in the electrophoresis apparatus according to the present embodiment, the septum does not need to be used, as a different effect from the embodiment described above. As a result, the number of components is reduced and it is possible to manufacture the electrophoresis medium receptacle 105 at a low cost.

### Embodiment 3

An electrophoresis apparatus according to the present embodiment is described with reference to FIG. 13. The present embodiment is described focusing on differences from Embodiments 1 and 2 described above.

In the capillary electrophoresis apparatus according to the embodiment described above, the holes, from which the electrophoresis medium 222 of the electrophoresis medium receptacle 105 is sealed, are individually provided. However, it is not necessary to provide the holes individually, but the respective holes may be continuous as one. The capillary electrophoresis apparatus according to the present embodiment employs an example in which the holes, from which the electrophoresis medium 222 of the electrophoresis medium receptacle 105 is sealed, are continuous, and is described with reference to FIG. 13.

FIG. 13 illustrates views (a plan view and an A-A sectional view) of a configuration of the electrophoresis medium receptacle 105 according to the present embodiment. As illustrated in FIG. 13, the holes, from which the electrophoresis medium 222 of the electrophoresis medium receptacle 105 is sealed, are continuous through a communication portion 601 inside the receptacle 214. In this manner, in the electrophoresis apparatus according to the present embodiment, it is possible to easily perform the sealing of the electrophoresis medium 222 in the electrophoresis medium receptacle 105, as a different effect from the embodiment described above.

### Embodiment 4

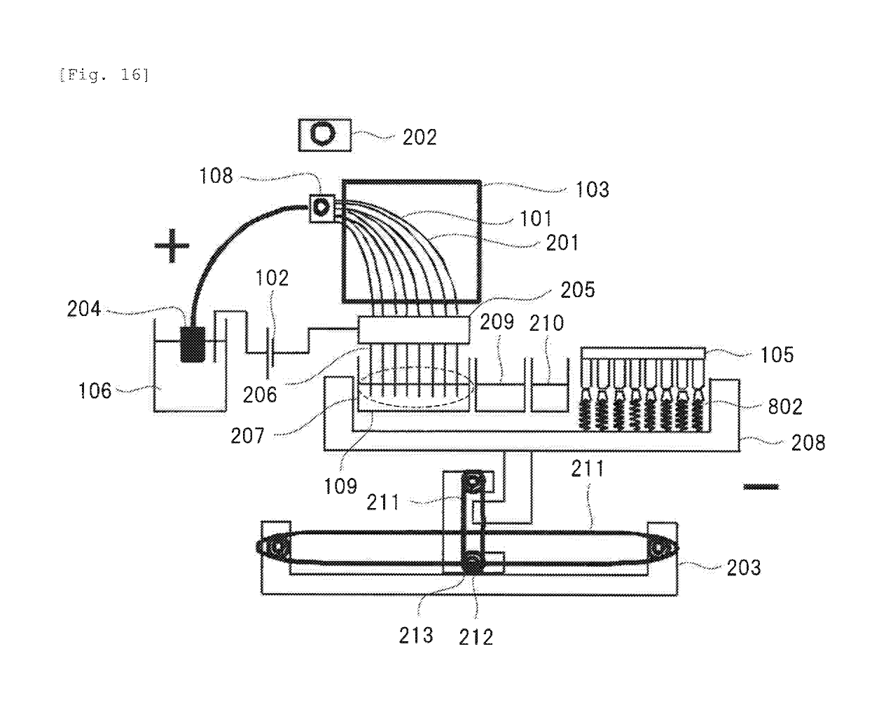

An electrophoresis apparatus according to the present embodiment is described with reference to FIG. 14. The present embodiment is described focusing on differences from Embodiments 1 to 3 described above.

In the capillary electrophoresis apparatus according to the embodiment described above, the same number of septa surrounding the capillary cathode ends 207 is used as the number of the capillary cathode ends 207. However, there is no need to divide the septum into the same number of the capillary cathode end 207, but the respective septa 215 may be continuous to each other. The capillary electrophoresis apparatus according to the present embodiment employs an example in which the respective septa 215 are continuous to each other and is described with reference to FIG. 14.

FIG. 14 is a view (exploded perspective view) illustrating a configuration of the electrophoresis medium receptacle 105 according to the present embodiment. As illustrated in FIG. 14, the respective septa 215 interposed between the receptacle 214 and the cover 216 are continuous to each other. In this manner, in the electrophoresis apparatus according to the present embodiment, it is possible to reduce the number of components of the electrophoresis medium receptacle 105, as a different effect from the embodiment described above.

### Embodiment 5

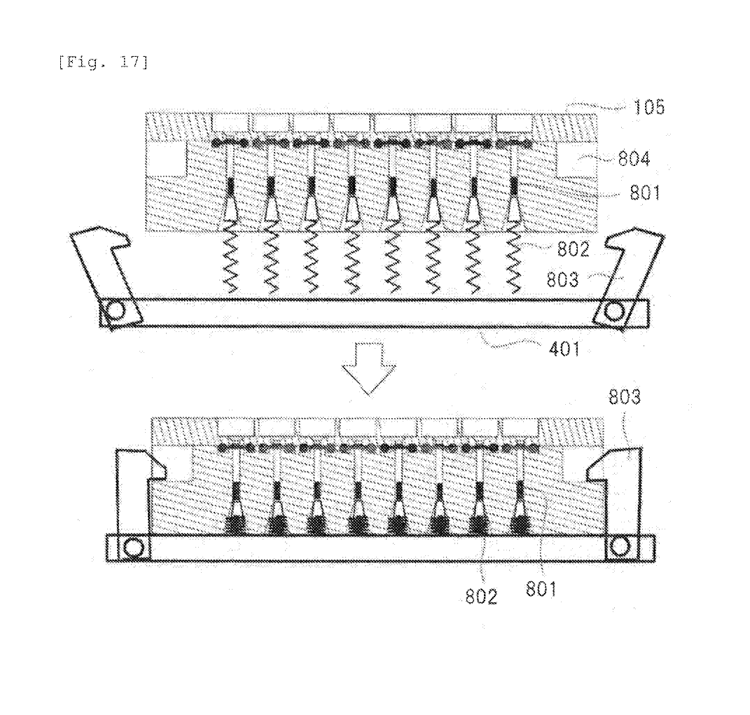

An electrophoresis apparatus according to the present embodiment is described with reference to FIG. 15 to FIG. 18. The present embodiment is described focusing on differences from Embodiments 1 to 4 described above.

In the capillary electrophoresis apparatus according to the embodiment described above, the case, where the capillary 101 is filled with the electrophoresis medium 222 due to the pressure produced when every capillary cathode end 207 is inserted into the electrophoresis medium receptacle 105, is described. However, before the capillary cathode end 207 is inserted into the electrophoresis medium receptacle 105, the pressure in the electrophoresis medium receptacle 105 may be increased. The capillary electrophoresis apparatus according to the present embodiment employs an example in which the pressure in the electrophoresis medium receptacle 105 is increased before the capillary cathode end 207 is inserted into the electrophoresis medium receptacle 105 and description thereof is as follows.

The basic configuration of the capillary electrophoresis apparatus according to the present embodiment is the same as that of the embodiments described above. Hereinafter, components different from those in the embodiments described above will be described with reference to the drawings.

<Structure of Electrophoresis Medium Receptacle>

FIG. 15 illustrates views (a plan view and an A-A sectional view) of a configuration of the electrophoresis medium receptacle 105 according to the present embodiment. As illustrated in FIG. 15, similar to Embodiment 1 described above, the electrophoresis medium receptacle 105 as a feature in the present embodiment includes the cover 216, the septum 215, and the receptacle 214. In addition, the electrophoresis medium receptacle 105 includes a clip receiving portion 804, which is used for fixing of the electrophoresis medium receptacle 105. Meanwhile, a plunger 801, which is used for a syringe or the like, is provided on the bottom side of the electrophoresis medium receptacle 105.

<Operation of Overall Electrophoresis Apparatus>

FIG. 16 is a view illustrating an overview of an electrophoresis apparatus according to the present embodiment.

FIG. 16 illustrates an installation state of the electrophoresis medium receptacle 105 during the electrophoresis. Further, a driving operation of the auto-sampler 203, an applying operation of voltage for the electrophoresis, or the like in the electrophoresis apparatus to be described below is realized by using a control unit (for example, a computer) (not illustrated). As a characteristic point with respect to the embodiment described above, a spring plunger 802 is provided in the accommodation section 401 of the tray 208.

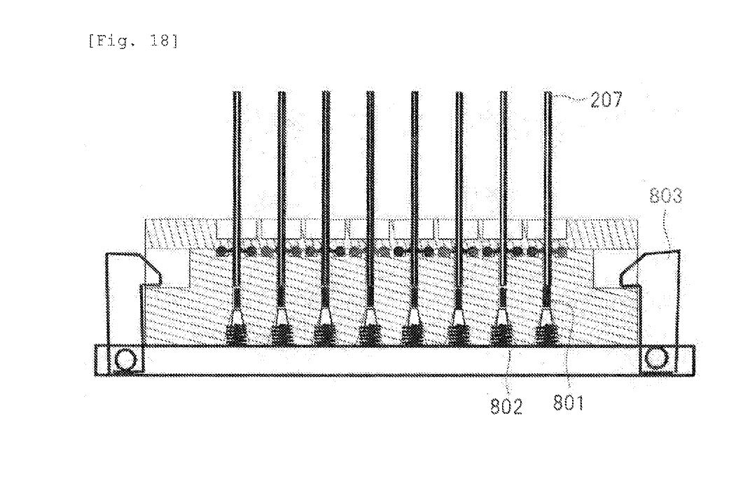

FIG. 17 and FIG. 18 illustrate processing steps when the capillary array 201 is filled with the electrophoresis medium 222. FIG. 17 is a view (sectional view) illustrating installation flow of the electrophoresis medium receptacle 105. FIG. 18 is a view (sectional view) illustrating a filling state with an electrophoresis medium 222.

First, the electrophoresis medium receptacle 105 is installed in the accommodation section 401 of the tray 208. FIG. 17 illustrates a state in which the electrophoresis medium receptacle 105 is installed in the accommodation section 401. In the accommodation section 401, the same number of spring plungers 802 as the number of plungers 801 of the electrophoresis medium receptacle 105 is provided. The electrophoresis medium receptacle 105 is installed such that the spring plungers 802 come into contact with the plungers 801 of the electrophoresis medium receptacle 105. At this time, the spring plungers 802 play a role of a positioning pin and the electrophoresis medium receptacle 105 is positioned at an arbitrary position.

In addition, an external force is applied to the plungers 801 of the electrophoresis medium receptacle 105 by the spring plungers 802, and the electrophoresis medium 222 in the electrophoresis medium receptacle 105 enters into a pressurized state. The clip receiving portion 804 is provided on the side surface of the electrophoresis medium receptacle 105. A clip portion 803 provided in the accommodation section 401 is fitted in the clip receiving portion 804, and thereby the electrophoresis medium receptacle 105 is fixed to the accommodation section 401. At the time of the fixing, a force produced by the spring plunger 802 is fixed to be a force greater than frictional force produced when the capillary cathode end 207 is pulled out.

Next, the tray 208 is driven in the horizontal direction by the auto-sampler 203 and the recessed portion 301 of the electrophoresis medium receptacle 105 is positioned at a position below the capillary cathode end 207.

Then, the tray 208 is lifted upward by the auto-sampler 203, the septum 215 of the electrophoresis medium receptacle 105 is penetrated, and the capillary cathode end 207 is inserted into the electrophoresis medium receptacle 105. FIG. 18 illustrates a state of immediately after the insertion. The sealing structure between the capillary cathode end 207 and the septum 215 and an operation of the apparatus are the same as in Embodiment 1.

In this manner, in the electrophoresis apparatus according to the present embodiment, it is possible to fill the capillary 101 with the electrophoresis medium 222 even in a case where the volume of the insertion of the capillary cathode end 207 is less than the interior volume of the capillary 101, as a different effect from the embodiment described above. In other words, it is possible to reduce the outer diameter of the capillary cathode end 207 or to shorten a length of the insertion of the capillary cathode end 207.

### Embodiment 6

An electrophoresis apparatus according to the present embodiment is described. The present embodiment is described focusing on differences from Embodiments 1 to 5 described above.

In the capillary electrophoresis apparatus according to the embodiment described above, the interior pressure of the receptacle is increased due to a force applied from the outside of the electrophoresis medium receptacle 105. However, the interior pressure may be increased using properties of the electrophoresis medium 222. The capillary electrophoresis apparatus according to the present embodiment employs an example in which the interior pressure is increased using the properties of the electrophoresis medium 222.

For example, when the electrophoresis medium 222 is sealed in the electrophoresis medium receptacle 105, the electrophoresis medium having a low temperature is sealed. The electrophoresis medium receptacle 105 returns to room temperature for the first time when the user starts using. At that time, the volume of the electrophoresis medium 222 is increased due to thermal expansion of the electrophoresis medium 222 in the sealed space, and thus, pressure higher than the atmospheric pressure is produced. In this manner, in the electrophoresis apparatus according to the present embodiment, it is possible to increase the interior pressure, using the properties of the electrophoresis medium 222, without a mechanism or the like which applies pressure from the outside, as a different effect from the embodiment described above.

### Embodiment 7

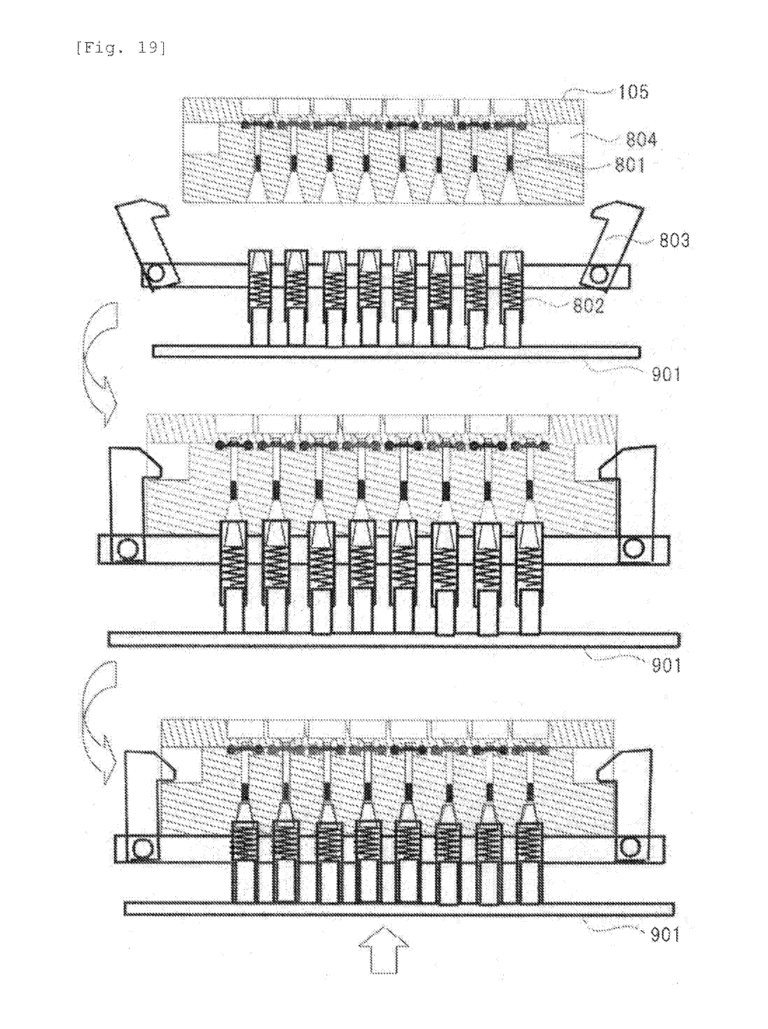

An electrophoresis apparatus according to the present embodiment is described with reference to FIG. 19. The present embodiment is described focusing on differences from Embodiments 1 to 6 described above.

In the capillary electrophoresis apparatus according to the embodiment described above, the pressure in the electrophoresis medium receptacle 105 is increased before the capillary cathode end 207 is inserted into the electrophoresis medium receptacle 105. However, the pressure in the electrophoresis medium receptacle 105 may be increased after the insertion of the capillary cathode end 207. The capillary electrophoresis apparatus according to the present embodiment employs an example in which the pressure in the electrophoresis medium receptacle 105 is increased after the insertion of the capillary cathode end 207 and is described with reference to FIG. 19.

FIG. 19 is a view (sectional view) illustrating installation flow of the electrophoresis medium receptacle 105 according to the present embodiment. As illustrated in FIG. 19, a pushing-out mechanism 901, which pushes up the spring plunger 802 of the tray 208, is provided and the plunger 801 is pushed up though the spring plunger 802 by the pushing-out mechanism 901 after the insertion of the capillary cathode end 207 into the electrophoresis medium receptacle 105. In this manner, in the electrophoresis apparatus according to the present embodiment, it is possible to install the electrophoresis medium receptacle 105 more simply because a force in a direction reverse to the installation direction is not received when a user installs the electrophoresis medium receptacle 105, as a different effect from the embodiment described above.

### Embodiment 8

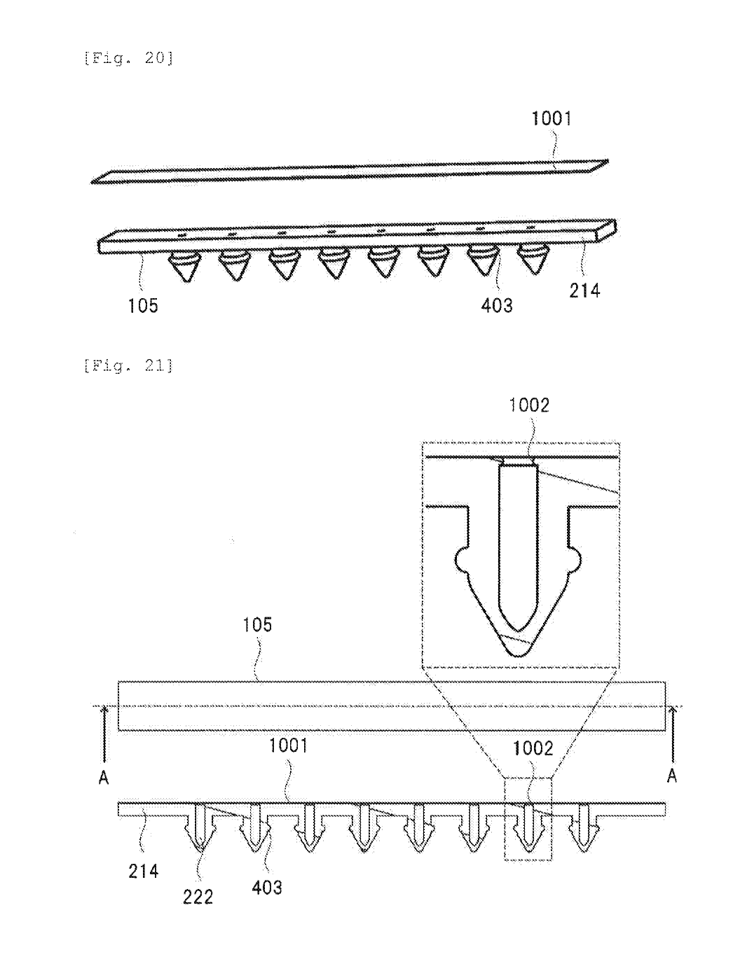

An electrophoresis apparatus according to the present embodiment is described with reference to FIG. 20 to FIG. 23. The present embodiment is described focusing on differences from Embodiments 1 to 7 described above.

In the capillary electrophoresis apparatus according to the embodiment described above, the electrophoresis medium receptacle 105 is maintained to be sealed by the septum 215 under any circumstances. However, In consideration of the filling of the capillary 101 with the electrophoresis medium 222, the sealing state of the electrophoresis medium receptacle may not be maintained except for during storage of the electrophoresis medium receptacle 105 and during filling of the capillary 101 with the electrophoresis medium 222. The capillary electrophoresis apparatus according to the present embodiment employs an example in which the sealing state of the electrophoresis medium receptacle is not maintained except for during storage of the electrophoresis medium receptacle 105 and during filling of the capillary 101 with the electrophoresis medium 222, and description thereof is as follows.

Further, the basic configuration of the capillary electrophoresis apparatus according to the present embodiment is the same as that of the embodiments described above. Hereinafter, components different from those in the embodiments described above will be described with reference to the drawings.

<Structure of Electrophoresis Medium Receptacle>

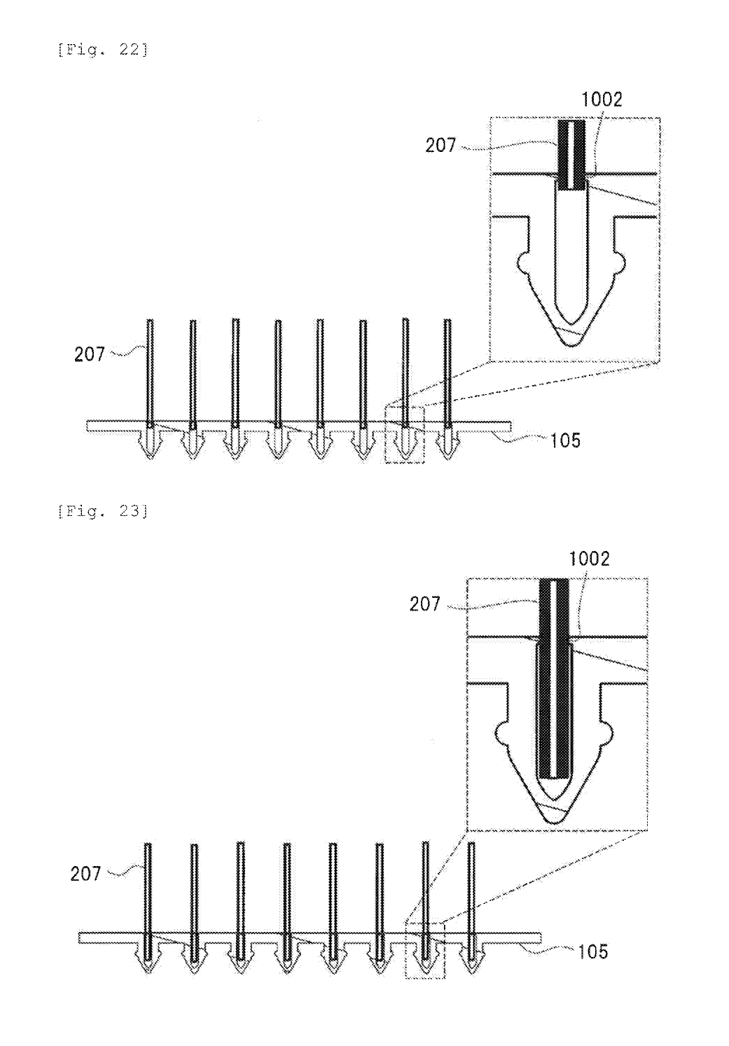

FIG. 20 to FIG. 23 illustrate detailed configurations of the electrophoresis medium receptacle 105 which is employed in the present embodiment. FIG. 20 is a view (exploded perspective view) illustrating a disassembled configuration of the electrophoresis medium receptacle 105. FIG. 21 illustrates views (a plan view, an A-A sectional view, and an enlarged sectional view of a portion) of the configuration of the electrophoresis medium receptacle 105. FIG. 22 illustrates views (a sectional view and an enlarged sectional view of a portion) of a state of immediately after the insertion of the capillary cathode end 207. FIG. 23 illustrates views (a sectional view and an enlarged sectional view of a portion) of a state of the insertion of the capillary cathode end 207.

As illustrated in FIG. 20 and FIG. 21, the electrophoresis medium receptacle 105 is configured to include an evaporation preventing seal 1001 and the receptacle 214 in which the electrophoresis medium 222 is sealed. An interior protrusion 1002 which plays a role of sealing during the insertion of the capillary cathode end 207 is provided in the inside of the receptacle 214. In addition, the protrusion 403 similar to the embodiments described above is provided on the external portion of the receptacle 214 and is used for fixing the electrophoresis medium receptacle 105.

<Operation of Overall Electrophoresis Apparatus>

Next, a series of processing operations performed by the electrophoresis apparatus according to the present embodiment will be described.

First, the evaporation preventing seal 1001 is peeled off before the electrophoresis medium receptacle 105 is installed on the tray 208. Then, the electrophoresis medium receptacle 105 is installed in the accommodation section 401 of the tray 208.

Similar to the embodiments described above, the electrophoresis medium receptacle 105 is fixed by the protrusion 403 provided on the outer circumference of the cylindrical section of the electrophoresis medium receptacle 105.

Next, the tray 208 is driven in the horizontal direction by the auto-sampler 203 and the electrophoresis medium receptacle 105 is positioned at the position below the capillary cathode end 207.

Then, the tray 208 is lifted upward by the auto-sampler 203 and the capillary cathode end 207 is inserted into the electrophoresis medium receptacle 105. FIG. 22 illustrates a state of immediately after the insertion. The outer circumference of the capillary cathode end 207 comes into contact with the interior protrusion 1002 for the sealing, which is provided in the electrophoresis medium receptacle 105. In other words, at the moment, the electrophoresis medium receptacle 105 enters into the sealing state. A diameter of the interior protrusion 1002 for sealing is less than the capillary cathode end 207.

FIG. 23 illustrates a state in which the tray 208 is further lifted upward from the state described above. The capillary cathode end 207 comes into contact with the interior protrusion 1002 of the electrophoresis medium receptacle 105 and the sealing state is maintained. Accordingly, the electrophoresis medium 222 is compressed due to the insertion of the capillary cathode end 207, the pressure in the electrophoresis medium receptacle 105 is increased, and thereby the capillary 101 is filled with the electrophoresis medium 222.

Hereinafter, the operation during the electrophoresis is the same as that in the embodiments described above.

In this manner, in the electrophoresis apparatus according to the present embodiment, the sealing state of the electrophoresis medium receptacle 105 may not be maintained, except for during storage of the electrophoresis medium receptacle 105 and during the filling of the capillary 101 with the electrophoresis medium 222, as a different effect from the embodiment described above.

### Embodiment 91

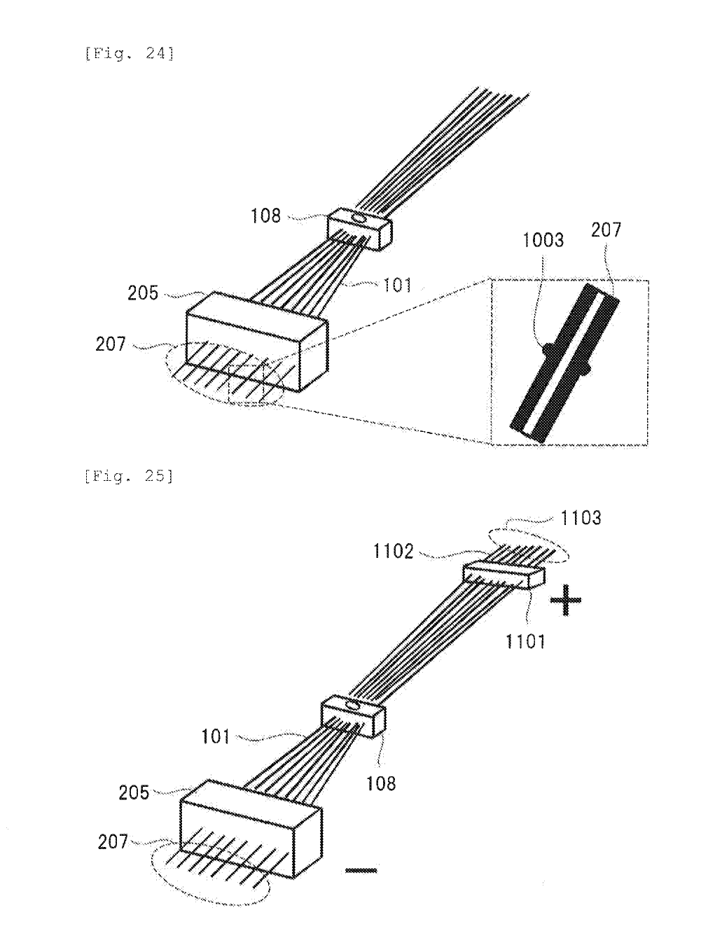

An electrophoresis apparatus according to the present embodiment is described with reference to FIG. 24. The present embodiment is described focusing on differences from Embodiments 1 to 8 described above.

In the capillary electrophoresis apparatus according to the embodiment described above, in order to enter into the sealing state, the interior protrusion 1002 for sealing is formed in the electrophoresis medium receptacle 105. However, a protrusion 1003 may be provided in the capillary cathode end 207. The capillary electrophoresis apparatus according to the present embodiment employs an example in which the protrusion 1003 is formed in the capillary cathode end 207 and is described with respect to FIG. 24.

FIG. 24 illustrates views (a perspective view and an enlarged sectional view of a portion) of the capillary array 201 according to the present embodiment. As illustrated in FIG. 24, the protrusion 1003 is provided on the outer circumference of the capillary cathode end 207. The protrusion 1003 has an outer diameter greater than the diameter of the hole into which the capillary cathode end 207 of the electrophoresis medium receptacle 105 is inserted. In this manner, in the electrophoresis apparatus according to the present embodiment, it is possible to easily manufacture the electrophoresis medium receptacle 105 because there is no need to form the interior protrusion 1002 on the electrophoresis medium receptacle 105 side, as a different effect from the embodiment described above.

### Embodiment 10

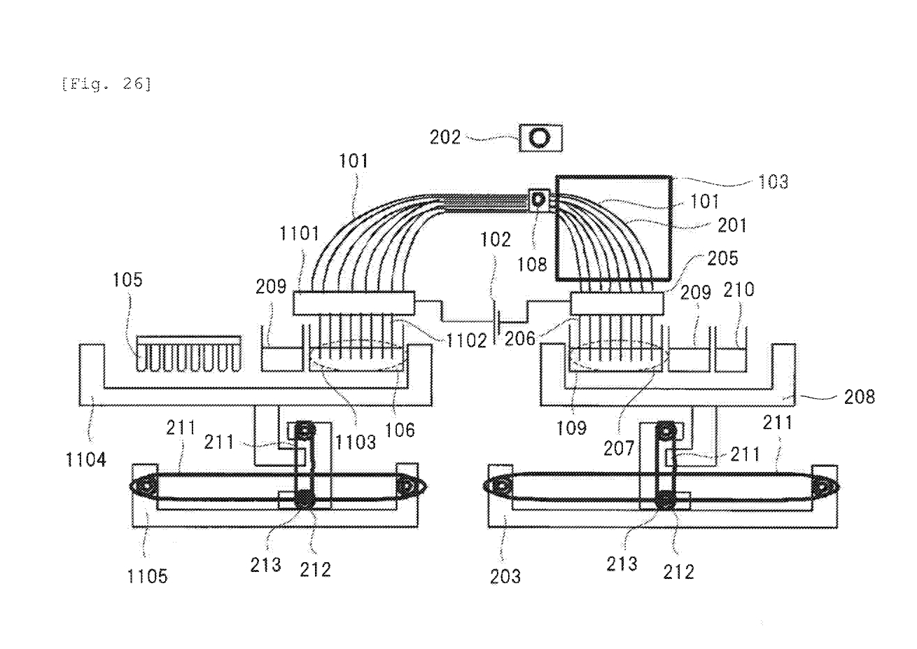

An electrophoresis apparatus according to the present embodiment is described with reference to FIG. 25 and FIG. 26. The present embodiment is described focusing on differences from Embodiments 1 to 9 described above.

In the capillary electrophoresis apparatus according to the embodiment described above, every capillary cathode end 207 is filled with the electrophoresis medium 222. However, it is possible to fill the capillary array 201 from the anode side with the electrophoresis medium 222. The capillary electrophoresis apparatus according to the present embodiment employs an example of an electrophoresis apparatus having a structure for filling with the electrophoresis medium 222 from a capillary anode end 1103, and description thereof is as follows.

Further, the basic configuration of the capillary electrophoresis apparatus according to the present embodiment is the same as that of the embodiments described above.

Hereinafter, components different from those in the embodiments described above will be described with reference to the drawings.

<Structure of Capillary Array>

FIG. 25 is a view (perspective view) illustrating the capillary array 201 according to the present embodiment. As illustrated in FIG. 25, in the characteristic capillary array 201 according to the present embodiment, the configuration (load header 205 and the capillary cathode end 207) on the cathode side of the capillary array 201 is the same as that in the embodiments described above. Meanwhile, similar to the cathode side, the capillary array 201 on the anode side is provided with an anode-side load header 1101. A tube-shaped anode electrode 1102 is provided in the anode-side load header 1101. The capillary 101 penetrates through the anode electrode 1102 and protrudes (hereinafter, referred to as a capillary anode end 1103) from the lower end of the anode electrode 1102.

<Overview of Electrophoresis Apparatus>

FIG. 26 is a view illustrating an overview of an electrophoresis apparatus according to the present embodiment. Hereinafter, a configuration of the apparatus will be described with reference to FIG. 26.

The filling of the capillary array 201 with the electrophoresis medium 222 and the structure of the electrophoresis medium receptacle 105 are the same as Embodiment 1 described above. Meanwhile, unlike Embodiment 1 described above, two auto-samplers 203, which transport the electrophoresis medium or the like, are provided at two positions on the cathode side and on the anode side.

On an anode-side tray 1104, the buffer solution receptacle A 106 that contains the buffer solution into which the capillary anode end 1103 is immersed, the pure water receptacle 209 that contains pure water for cleaning the capillary, and the electrophoresis medium receptacle 105 which contains the electrophoresis medium, are mounted.

An anode-side auto sampler 1105 is configured to include two timing belts 211 corresponding to the rightward-leftward direction (horizontal direction: X) and the upward-downward direction (vertical direction: Y), respectively, in FIG. 26, similar to the embodiments described above. Rotation of the two timing belts 211 enables the anode-side tray 1104 to be transported in the rightward-leftward and upward-downward directions. The transport in two axial directions enables the respective receptacles mounted on the anode-side tray 1104 to be positioned at a position facing the capillary anode end 1103. Further, the timing belts 211 are driven by the rotation of a motor 213 connected through a pulley 212.

On a cathode-side tray 208, the buffer solution receptacle B 109 that contains the buffer solution into which the capillary cathode end 207 is immersed, the pure water receptacle 209 that contains pure water for cleaning the capillary, and the sample receptacle 210 that contains the sample, are mounted.

<Operation of Overall Electrophoresis Apparatus>

Next, a series of processing operations by the electrophoresis apparatus according to the present embodiment will be described. Further, a drive operation of the auto-sampler or an applying operation of voltage for performing electrophoresis in the electrophoresis apparatus to be described below is realized by a control unit (for example, a computer) (not illustrated).

Hereinafter, processing steps when the capillary array 201 is filled with the electrophoresis medium 222 will be described.

First, the electrophoresis medium receptacle 105 is installed in the accommodation section 401 of the anode-side tray 1104. A structure of the accommodation section 401 of the anode-side tray 1104 is the same as Embodiment 1 described above.

Next, the anode-side tray 1104 is driven in the horizontal direction by the anode-side auto sampler 1105 and the recessed portion of the electrophoresis medium receptacle 105 is positioned at the position below the capillary anode end 1103.

Then, the anode-side tray 1104 is lifted upward by the anode-side auto sampler 1105. The capillary anode end 1103 penetrates through the septum 215 of the electrophoresis medium receptacle 105 and is inserted into the electrophoresis medium receptacle 105, and thereby the capillary 101 is filled with the electrophoresis medium 222. At this time, the capillary cathode end 207 is immersed into the pure ware contained in the pure water receptacle 209.

When the filling of the capillary 101 with the electrophoresis medium 222 is completed, the anode-side tray 1104 is transported downward by the anode-side auto sampler 1105 and the capillary anode end 1103 is pulled out from the electrophoresis medium receptacle 105.

Then, the anode-side auto sampler 1105 transports the anode-side tray 1104 and the capillary anode end 1103 is immersed in the pure water (for cleaning) contained in the pure water receptacle 209, and in the buffer solution contained in the buffer solution receptacle A 106, in this order.

Regarding the capillary cathode end 207, the capillary anode end 1103 is immersed in the buffer solution contained in the buffer solution receptacle A 106 and at the same time, the capillary cathode end is immersed in the sample contained in the sample receptacle 210 and in the buffer solution contained in the buffer solution receptacle B 109, in this order.

The electrophoresis is started in a state in which both the capillary anode end 1103 and the capillary cathode end 207 are immersed in the buffer solution.

In this manner, in the electrophoresis apparatus according to the present embodiment, it is possible to fill the capillary 101 with the electrophoresis medium 222 from the capillary anode end 1103, as a different effect from the embodiment described above.

### Embodiment 11

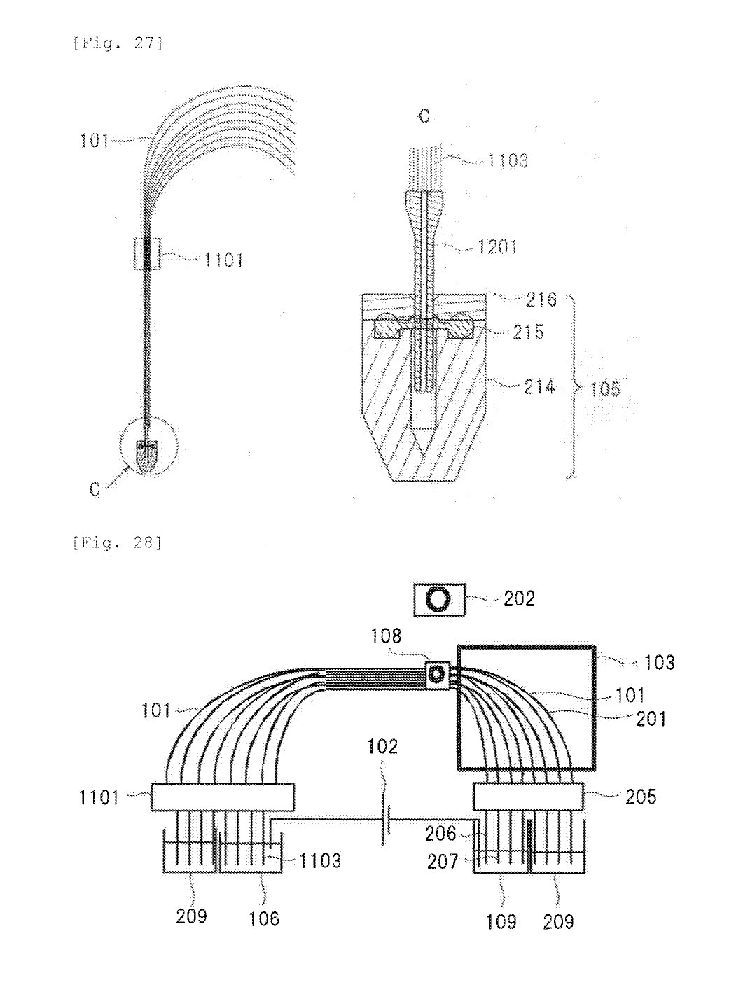

An electrophoresis apparatus according to the present embodiment is described with reference to FIG. 27. The present embodiment is described focusing on differences from Embodiments 1 to 10 described above.

In the capillary electrophoresis apparatus according to the embodiment described above, the electrophoresis medium receptacle 105 having the same number of electrophoresis medium sealing units as the capillaries 101 is used. However, the number of electrophoresis medium sealing units does not have to be the same as the number of the capillaries 101. The capillary electrophoresis apparatus according to the present embodiment employs an example in which the plurality of bundled capillaries 101 are inserted into the electrophoresis medium receptacle 105 and is described with reference to FIG. 27.

FIG. 27 illustrates views (a sectional view and an enlarged sectional view of a C portion) of a filling state with the electrophoresis medium 222 according to the present embodiment. As illustrated in FIG. 27, the capillary anode end 1103 is bundled in a metal tube 1201 by using an adhesive. When the capillary 101 is filled with the electrophoresis medium 222, similar to the embodiments described above, the plurality of (for example, eight) bundled capillaries 101 are inserted into the electrophoresis medium receptacle 105 along with the tube 1201. In this manner, in the electrophoresis apparatus according to the present embodiment, the plurality of bundled capillaries 101 are inserted into the electrophoresis medium receptacle 105, and thereby it is possible to more easily perform the filling of the capillaries 101 with the electrophoresis medium 222, as a different effect from the embodiment described above.

### Embodiment 12

An electrophoresis apparatus according to the present embodiment is described with reference to FIG. 28. The present embodiment is described focusing on differences from Embodiments 1 to 11 described above.

In the capillary electrophoresis apparatus according to the embodiment described above, every capillary 101 is filled with the electrophoresis medium 222 and the electrophoresis is performed. However, an arbitrary capillary 101 may be filled with the electrophoresis medium 222. The capillary electrophoresis apparatus according to the present embodiment employs an example in which an arbitrary capillary 101 is filled with the electrophoresis medium 222 and is described with reference to FIG. 28.

FIG. 28 is a view illustrating an overview of an electrophoresis apparatus according to the present embodiment. As illustrated in FIG. 28, when the electrophoresis is performed, only the capillaries 101 which are filled with the electrophoresis medium 222 are immersed in the buffer solution. The capillaries 101, which are not used in the electrophoresis, are immersed in the pure water regardless of the anode side or the cathode side. In an example in FIG. 28, the capillary cathode ends 207, which are filled with the electrophoresis medium 222, of all of the capillaries 101 of the capillary array 201, are immersed in the buffer solution contained in the buffer solution receptacle B 109 and the capillary anode ends 1103, which are filled with the electrophoresis medium 222, are immersed in the buffer solution contained in the buffer solution receptacle A 106. The other capillary cathode ends 207, which are not used in the electrophoresis, are immersed in the pure water contained in the pure water receptacle 209 and the other capillary anode ends 1103, which are not used in the electrophoresis, are immersed in the pure water contained in the pure water receptacle 209.

At this time, voltage or the like is appropriately applied corresponding to the number of the capillaries 101, which are used, by the control unit (for example, a computer) (not illustrated). In this manner, in the electrophoresis apparatus according to the present embodiment, it is possible to use the capillaries 101 as necessary, corresponding to the number of samples which are analyzed as a different effect from the embodiment described above.

As above, the invention made by the present inventor is specifically described, based on the embodiments; however, it is needless to say that the present invention is not limited to the embodiments described above and can be modified in various ways within a range without departing from the gist thereof. For example, the embodiments described above are described in detail, in order to describe the present invention in an easily understandable manner, but the present invention is not necessarily limited to the combination of entire configurations described above. In addition, a part of a configuration of one certain embodiment can be replaced with another configuration of another embodiment and one configuration of one embodiment can be added to another configuration of another embodiment. In addition, a part of the configuration of each of the embodiments can be added to, removed from, or replaced with another configuration.

### REFERENCE SIGNS LIST

101: capillary
102: high voltage power source
103: constant-temperature oven
104: electrophoresis medium filling unit
105: electrophoresis medium receptacle
106: buffer solution receptacle A
107: plunger pump
108: detector
109: buffer solution receptacle B
201: capillary array
202: receiving optical system
203: auto-sampler
204: capillary head
205: load header
206: cathode electrode
207: capillary cathode end
208: tray
209: pure water receptacle
210: sample receptacle
211: timing belt
212: pulley
213: motor
214: receptacle
215: septum
216: cover
217: snap fitting claw
218: snap fitting hole
219: pin portion
220: positioning hole
221: capillary cathode end inserting hole
222: electrophoresis medium
301: recessed portion
302: taper (septum)
303: taper (cover)
304: outer circumference
401: accommodation section
402: electrophoresis medium receptacle positioning hole
403: protrusion
501: capillary cathode end inserting portion
601: communication portion
801: plunger
802: spring plunger
803: clip portion
804: clip receiving portion
901: pushing-out mechanism
1001: evaporation preventing seal
1002: interior protrusion
1003: protrusion on capillary end
1101: anode-side load header
1102: anode electrode
1103: capillary anode end
1104: anode-side tray
1105: anode-side auto sampler
1201: metal cylinder

1.-15. (canceled)

16. An electrophoresis medium receptacle comprising:
a sealing member which maintains a receptacle main body filled with an electrophoresis medium, in a sealing state, and which can be pierced by the capillary,
wherein the electrophoresis medium is supplied to the inside of the capillary due to pressure produced when the capillary pierces the sealing member that seals the receptacle main body filled with the electrophoresis medium.

17. The electrophoresis medium receptacle according to claim 16,
wherein the pressure produced, when the capillary pierces the sealing member, is pressure produced due to an increase in pressure in the receptacle main body, with compression of the electrophoresis medium, by an amount of a volume of the capillary inserted into the receptacle main body.

18. The electrophoresis medium receptacle according to claim 17,
wherein the volume of the capillary inserted into the receptacle main body is greater than the interior volume of the capillary.

19. The electrophoresis medium receptacle according to claim 18,
wherein the sealing member is formed of a material which is likely to be elastically deformed and maintains the sealing state of the receptacle main body through elastic deformation, even when the capillary penetrates through the member.

20. The electrophoresis medium receptacle according to claim 19,
wherein the sealing member is formed of rubber or a resin which is likely to be elastically deformed.

21. The electrophoresis medium receptacle according to claim 16,
wherein the capillary is configured to be one capillary or a capillary array as an aggregated set of a plurality of the capillaries, and
wherein the sealing member is configured to have same arrangement corresponding to the configuration of the capillary.

22. The electrophoresis medium receptacle according to claim 20,
wherein the sealing member is formed of the rubber and has a recessed portion into which the capillary is inserted, a taper from which an external force is applied toward an insertion portion of the capillary, and an O-ring with which a gap with the receptacle main body is filled.

23. The electrophoresis medium receptacle according to claim 20,
wherein the receptacle main body including the sealing member is formed of the resin and a portion of the sealing member, through which the capillary penetrates, is thinner than the other portion in a thickness of the resin.

24. The electrophoresis medium receptacle according to claim 16,
wherein the pressure in the receptacle main body is increased before the insertion of the capillary.

25. The electrophoresis medium receptacle according to claim 16,
wherein the pressure in the receptacle main body is increased after the insertion of the capillary.

26. The electrophoresis medium receptacle according to claim 16,
wherein the sealing state of the receptacle main body is maintained only during storage of the electrophoresis medium receptacle and during filling of the inside of the capillary with the electrophoresis medium.

27. The electrophoresis medium receptacle according to claim 16,
wherein, when the inside of the capillary is filled with the electrophoresis medium, the filling with the electrophoresis medium is performed from the cathode side of the capillary or from the anode side of the capillary.

28. The electrophoresis medium receptacle according to claim 16,
wherein, when the inside of the capillary is filled with the electrophoresis medium, of the entire capillary, only a part of the capillary is filled with the electrophoresis medium.

29. An electrophoresis apparatus comprising:
one capillary or a capillary array as an aggregated set of a plurality of capillaries;
a receiving optical system that irradiates a sample in the capillary with light and detects fluorescence of the sample;
a high voltage power source that applies high voltage to the capillary;
a constant-temperature oven which maintains the capillary at a constant temperature; and
a transport machine that transports a plurality of receptacles including a sample receptacle and an electrophoresis medium receptacle,
wherein the electrophoresis medium receptacle includes a sealing member which maintains a receptacle main body filled with an electrophoresis medium, in a sealing state, and which can be pierced by the capillary, and
wherein the electrophoresis medium is supplied to the inside of the capillary due to pressure produced when the capillary pierces the sealing member that seals the receptacle main body filled with the electrophoresis medium.

30. The electrophoresis apparatus according to claim 29,
wherein the pressure produced, when the capillary pierces the sealing member, is pressure produced due to an increase in pressure in the receptacle main body, with compression of the electrophoresis medium, by an amount of a volume of the capillary inserted into the receptacle main body, and
wherein the volume of the capillary inserted into the receptacle main body is greater than the interior volume of the capillary.

31. The electrophoresis medium receptacle according to claim 16, further comprising:
a plunger that is provided on the bottom side of the receptacle main body,
wherein an external force is applied to the plunger, and the electrophoresis medium is pressurized.

32. The electrophoresis medium receptacle according to claim 31, further comprising:
a spring plunger which applies an external force to the plunger.
